(19) United States
(12) Patent Application Publication
(10) Pub. No.: US 2007/0008446 A1
(43) Pub. Date: Jan. 11, 2007

(54) Array substrate, method of manufacturing the same and liquid crystal display panel having the same

(75) Inventors: Yeon-Kyu Moon, Seoul (KR); Hyeong-Jun Park, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/483,790

(22) Filed: Jul. 7, 2006

(30) Foreign Application Priority Data
Jul. 8, 2005 (KR) 10-2005-61751

(51) Int. Cl. G02F 1/136

(52) U.S. Cl. 349/43

(57) ABSTRACT

An array substrate includes a display region having a plurality of pixel parts and a peripheral region surrounding the display region. The array substrate also includes a switching element, a pixel element, a metal pattern, a pixel electrode pattern and an alignment layer. The switching element is in each of the pixel parts. The switching element is electrically connected to gate and source lines. The pixel electrode is electrically connected to the switching element. The metal pattern part is in the peripheral region. The pixel electrode pattern part is on the metal pattern part. The alignment layer is on the pixel electrode and the pixel electrode pattern part. Therefore, the array substrate may be securely combined with an alignment substrate to improve an impact resistance of a display device.

### CROSS REFERENCE TO RELATED APPLICATION

The present application claims priority from Korean Patent Application No. 2005-61751 filed on Jul. 8, 2005, the disclosure of which is hereby incorporated herein by reference in its entirety.

### BACKGROUND OF THE INVENTION

1. Field of the Invention

The present invention relates to an array substrate, a method of manufacturing the array substrate and a liquid crystal display (LCD) panel having the array substrate. More particularly, the present invention relates to an array substrate having improved impact resistance, a method of manufacturing the array substrate and a liquid crystal display (LCD) panel having the array substrate.

2. Description of the Related Art

An LCD panel, in general, includes an array substrate, an alignment substrate, and a liquid crystal layer between the two substrates. The array substrate includes a plurality of thin film transistors (TFT). The alignment substrate is approximately the same size as and positioned substantially parallel to the array substrate.

A sealing member is interposed between the array substrate and the alignment substrate so that the array substrate is combined with the alignment substrate. The sealing member is placed on a peripheral region of the array substrate or the alignment substrate.

In order to decrease the overall thickness of the LCD panel, a gate circuit part is integrated on the array substrate. An alignment layer is overlapped with the sealing member to decrease corrosion of the gate circuit part.

However, the adhesive strength between the alignment layer and the sealing member is weak so that the sealing member is easily detached from the alignment layer by external impact. Therefore, the array substrate is not securely combined with the alignment substrate.

### SUMMARY OF THE INVENTION

The present invention provides an array substrate having improved impact resistance.

The present invention also provides a method of manufacturing the above-mentioned array substrate.

The present invention also provides a liquid crystal display (LCD) panel having the above-mentioned array substrate.

An array substrate in accordance with one embodiment of the present invention includes a display region having a plurality of pixel parts and a peripheral region surrounding the display region. The array substrate also includes a switching element, a pixel element, a metal pattern, a pixel electrode pattern and an alignment layer. The switching element is in each of the pixel parts. The switching element is electrically connected to a gate line and a source line. The pixel electrode is electrically connected to the switching element. The metal pattern part is in the peripheral region, and the pixel electrode pattern part is on the metal pattern part. The alignment layer is on the pixel electrode and the pixel electrode pattern part.

In another aspect, the invention is a method of manufacturing an array substrate including a display region and a peripheral region. A plurality of switching elements, a plurality of signal transmitting parts and a gate circuit part that applies a driving signal to the switching elements through the signal transmitting parts are formed on a substrate. A passivation layer is formed on the substrate. The passivation layer has a contact hole through which each of the switching elements is partially exposed. A pixel electrode that is electrically connected to each of the switching elements through the contact hole and a plurality of first pixel electrode patterns are formed on the passivation layer. The first pixel electrode patterns are on the signal transmitting lines. An alignment layer is formed on the pixel electrode and the first pixel electrode patterns.

In yet another aspect, the invention is an LCD panel that includes a first substrate, a second substrate, a liquid crystal layer and a sealing member. The first substrate has a first alignment layer. The second substrate has a display region and a peripheral region. The second substrate includes a plurality of pixel electrodes, a metal pattern part, a pixel electrode pattern part and a second alignment layer. The pixel electrodes are on the substrate in the display region. The metal pattern part is on the substrate in the peripheral region. The pixel electrode pattern part is on the metal pattern in the peripheral region. The second alignment layer is on the pixel electrodes and the pixel electrode pattern part. The liquid crystal layer is interposed between the first and second substrates. The sealing member is interposed between the first and second substrates in the peripheral region to contain the liquid crystal layer between the first and second substrates.

According to the present invention, a portion of the pixel electrode patterns is formed in the attaching region in which the sealing member is formed to increase the adhesive strength between the alignment layer and the passivation layer, thereby increasing the adhesive strength between the array substrate and the alignment substrate.

### BRIEF DESCRIPTION OF THE DRAWINGS

The above and other advantages of the present invention will become more apparent by describing in detail exemplary embodiments thereof with reference to the accompanying drawings, in which:

FIG. 1 is a plan view showing a liquid crystal display (LCD) panel in accordance with one embodiment of the present invention;

FIG. 2 is an enlarged plan view showing an array substrate shown in FIG. 1;

FIG. 3 is an enlarged plan view showing portions ‘A’, ‘B’ and ‘C’ shown in FIG. 2;

FIG. 4 is a cross-sectional view taken along a line ‘I-I’ shown in FIG. 3;

FIG. 5 is a cross-sectional view showing an array substrate in accordance with another embodiment of the present invention;

FIGS. 6 to 9 are cross-sectional views showing a method of manufacturing the array substrate shown in FIG. 3; and

FIG. 10 is a cross-sectional view showing the LCD panel shown in FIG. 1.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

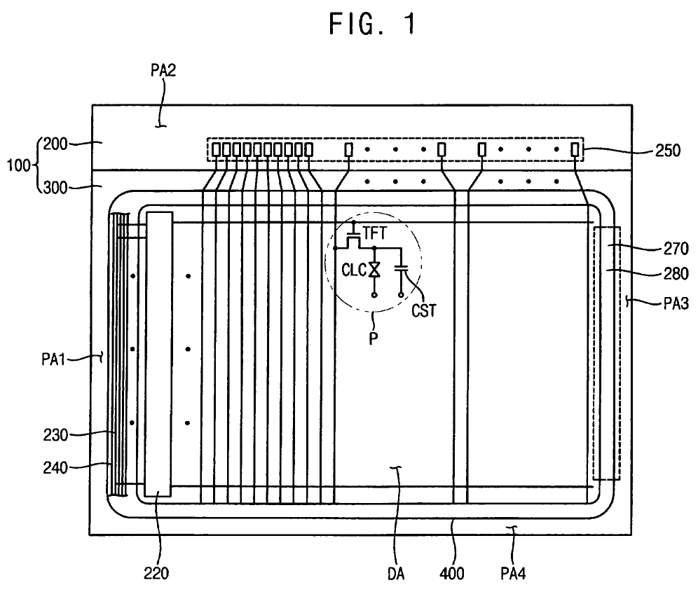

FIG. 1 is a plan view showing a liquid crystal display (LCD) panel in accordance with one embodiment of the present invention.

Referring to FIG. 1, the LCD panel 100 includes an array substrate 200, a second substrate 300, a sealing member 400 and a liquid crystal layer (not shown).

The array substrate 200 is designed to be combined with the second substrate 300. The array substrate 200 is combined with the second substrate 300 through the sealing member 400. The liquid crystal layer (not shown) is interposed between the array substrate 200 and the second substrate 300.

The array substrate 200 includes a display region DA, a first peripheral region PA1, a second peripheral region PA2, a third peripheral region PA3 and a fourth peripheral region PA4. The first, second, third and fourth peripheral regions PA1, PA2, PA3 and PA4 surround the display region DA.

A plurality of source lines DL, a plurality of gate lines GL and a plurality of pixel parts P are formed in the display region DA. The source lines DL extend in a first direction. The gate lines GL extend in a second direction that is substantially perpendicular to the first direction. The pixel parts P are defined by the source and gate lines DL and GL adjacent to each other. Each of the pixel parts P includes a switching element TFT, a liquid crystal capacitor CLC and a storage capacitor CST.

A gate circuit part 220 and a signal transmitting part 230 are in the first peripheral region PA1. The gate circuit part 220 includes a shift register that has a plurality of stages that are electrically connected to each other. The gate circuit part 220 applies gate signals to the gate lines GL.

The signal transmitting part 230 includes a plurality of signal lines through which driving signals are applied to the stages of the shift register. The driving signals include a gate off voltage Voff, a first clock signal CK, a second clock signal CKB and a vertical start signal STV.

A first pixel electrode pattern part 240 is formed on the signal transmitting part 230. The first pixel electrode pattern part 240 is on signal lines in an attaching region. As used herein, the “attaching region” is where the sealing member 400 is formed.

That is, the first pixel electrode pattern part 240 increases an adhesive strength between a passivation layer (not shown) on which the first pixel electrode pattern part 240 is formed and an alignment layer (not shown) on the first pixel electrode pattern part 240.

The gate circuit part 220 applies gate signals to the gate lines GL in the display region DA.

A source pad part 250 is formed in the second peripheral region PA2. The source pad part 250 applies the data signals to the source lines DL in the display region DA. A plurality of chips is mounted on the source pad part 250. Alternatively, a single chip may be mounted on the source pad part 250.

A height difference compensating part 270 is formed in the third peripheral region PA3 to decrease a height difference between the gate circuit part 220 and the third peripheral region PA3. A second pixel electrode pattern part 280 is formed on the height difference compensating part 270. The second pixel electrode pattern part 280 is on the height difference compensating part 270 in the attaching region in which the sealing member 400 is combined with the array substrate 200.

That is, the second pixel electrode pattern part 280 increases the adhesive strength between the passivation layer (not shown) on which the second pixel electrode pattern part 280 is formed and the alignment layer (not shown) that is on the second pixel electrode pattern part 280.

The second substrate 300 is aligned with the array substrate 200. A common electrode, in general, is formed to match the general shape of a color filter pattern. Likewise, a pixel electrode is formed to match the general shape of each of the pixel parts P.

The sealing member 400 is in the first, second, third and fourth peripheral regions PA1, PA2, PA3 and PA4. In particular, the sealing member 400 covers the signal transmitting part 230 in the first peripheral region PA1 and the height difference compensating part 270 in the third peripheral region PA3.

The sealing member 400 is in the first pixel electrode pattern part 240 that is on the signal transmitting part 230 and the second pixel electrode pattern part 280 that is on the height difference compensating part 270.

An adhesive strength between the alignment layer and a pixel electrode pattern that includes indium tin oxide (ITO) is stronger than an adhesive strength between the alignment layer and the passivation layer. The pixel electrode pattern that has higher adhesive strength against the alignment layer than the passivation layer is formed in the attaching region so that the passivation layer is securely combined with the alignment layer through the pixel electrode pattern, thereby increasing the adhesive strength between the array substrate 200 and the second substrate 300.

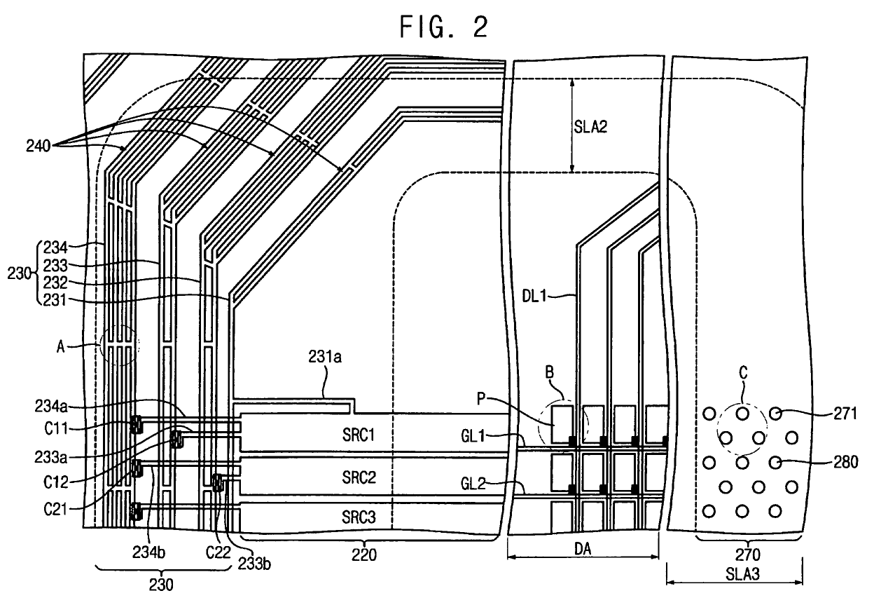

FIG. 2 is an enlarged plan view showing the array substrate of FIG. 1.

Referring to FIGS. 1 and 2, the array substrate 200 includes the display region DA in which the pixel parts P are formed and the first, second, third and fourth peripheral regions PA1, PA2, PA3 and PA4 that surround the display region DA.

The gate circuit part 220, the signal transmitting part 230 that includes a source metal pattern, and the first pixel electrode pattern part 240 that is on the signal transmitting part 230 are in the first peripheral region PA1.

The height difference compensating part 270 that includes a gate metal layer and the second pixel electrode pattern part 280 that is on the height difference compensating part 270 are in the third peripheral region PA3 that corresponds to the first peripheral region PA1. The height difference compensating part 280 is formed from the substantially same material as the gate line. Alternatively, the height difference compensating part 280 may be formed from the substantially same material as the source line.

The first, second and third peripheral regions PA1, PA2 and PA3 include the attaching region SLA1, SLA2 and SLA3 in which the sealing member 400 is combined with the array substrate 200. The fourth peripheral region PA4 may also include an attaching region on which the sealing member 400 is combined with the array substrate 200.

The gate circuit part 220 that is in the first peripheral region PAl includes the stages SRC1, SRC2, SRC3, . . . that apply the gate signals to the gate lines. Output terminals of the stages are electrically connected to the gate lines GL1, GL2, GL3, that are in the display region DA.

The signal transmitting part 230 includes the signal lines through which the driving signals are applied to the gate circuit part 220. The signal transmitting part 230 may be formed from a source metal layer or a gate metal layer. The source metal layer is substantially the same layer as the metal layer for forming source/drain electrode of the switching element TFT, and the gate metal layer is substantially the same layer as the metal layer for forming the gate electrode of the switching element TFT.

The driving signals include the gate off voltage Voff, the first clock signal CK, the second clock signal CKB and the vertical start signal STV. The gate off voltage Voff determines the low level of the gate signal. The first clock signal CK controls an output of odd-numbered gate signals. The second clock signal CK controls an output of even numbered gate signals. A driving of the gate circuit part 220 is started using the vertical start signal STV.

Particularly, the vertical start signal STV, the first clock signal CK, the second clock signal CKB and the gate off voltage Voff are transmitted through a first signal line 231, a second signal line 232, a third signal line 233 and a fourth signal line 234, respectively.

The odd numbered stages SRC1 and SRC3 are electrically connected to the third and fourth signal lines 233 and 234 through a first connecting line 233a and a second connecting line 234a, respectively. The first and second connecting lines 233a and 234a of the odd numbered stages SRC1 and SRC3 are electrically connected to the third and fourth signal lines 233 and 234 through a first contact portion C11 and a second contact portion C12, respectively. That is, when the signal transmitting part 230 includes the source metal layer, the first and second connecting lines 233a and 234a of the odd numbered stages SRC1 and SRC3 include the gate metal layer. Alternatively, the signal transmitting part 230 may include the gate metal layer, and the first and second connecting lines 233a and 234a of the odd numbered stages SRC1 and SRC3 may include the source metal layer.

The vertical start signal STV is applied to the first stage SRC1 through a connecting line 231a that is electrically connected to the first signal line 231.

The even numbered stages SRC2 are electrically connected to the second and fourth signal lines 232 and 234 through a first connecting line 233b and a second connecting line 234b, respectively. The first and second connecting lines 233b and 234b of the even numbered stages SRC2 are electrically connected to the second and fourth signal lines 232 and 234 through a first contact portion C21 and a second contact portion C22 of the even numbered stages SRC2, respectively. That is, when the signal transmitting part 230 is formed from the source metal layer, the first and second connecting lines 233b and 234b of the even numbered stages SRC2 are formed from the gate metal layer. Alternatively, the signal transmitting part 230 may be formed from the gate metal layer, and the first and second connecting lines 233b and 234b of the even numbered stages SRC2 may be formed from the source metal layer.

The first pixel electrode pattern part 240 includes the first, second, third and fourth signal lines 231, 232, 233 and 234. The first pixel electrode pattern part 240 may be electrically insulated from the first, second, third and fourth contact portions C11, C12, C21 and C22 that are from the pixel electrode pattern. The first pixel electrode pattern part 240 is formed on the signal transmitting part 230 in the attaching region SLA1.

The height difference compensating part 270 is in the third peripheral region PA3. The height difference compensating part 270 includes a plurality of dummy metal patterns 271 to even out the height difference between the third peripheral region PA3 and the first peripheral region PAl in which the gate circuit part 220 is formed. The dummy metal patterns 271 may be formed from the gate metal layer. Alternatively, the dummy metal patterns 271 may be formed from the source metal layer.

The second pixel electrode pattern part 280 may include the pixel electrode pattern, and a plurality of metal patterns corresponding to the dummy metal patterns 271 of the height difference compensating part 270, respectively. The second pixel electrode pattern part 280 may correspond to the dummy metal patterns 271 in the attaching region SLA2.

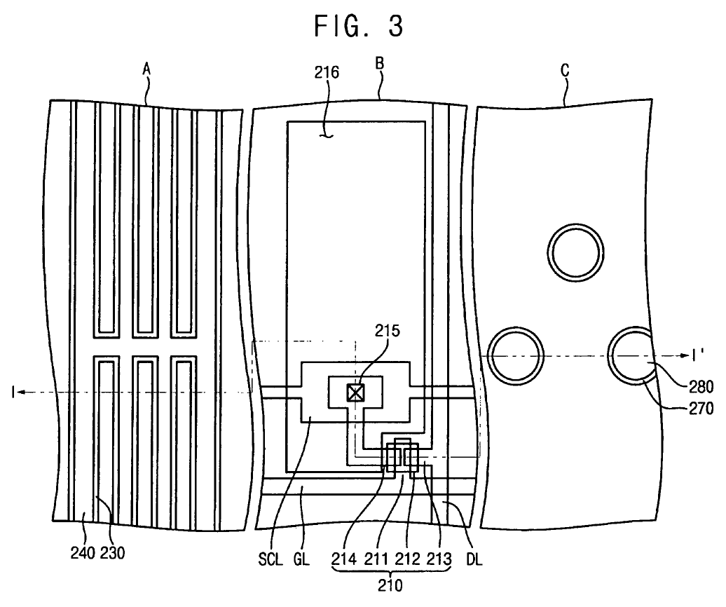

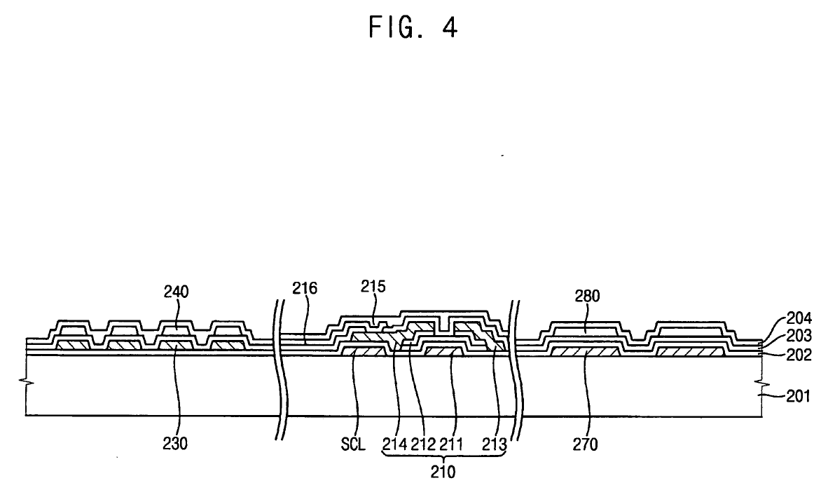

FIG. 3 is an enlarged plan view showing portions ‘A’, ‘B’ and ‘C’ shown in FIG. 2. FIG. 4 is a cross-sectional view taken along the line I-I′ shown in FIG. 3.

Referring to FIGS. 2 to 4, the first pixel electrode pattern part 240 is formed on the signal transmitting part 230 in the first peripheral region RA1. The second pixel electrode pattern part 280 is on the difference compensating part 270 in the third peripheral region PA3.

The array substrate 200 includes a first base substrate 201 having the display region DA, the first peripheral region PA1, the second peripheral region PA2, the third peripheral region PA3 and the fourth peripheral region PA4. The first, second, third and fourth peripheral regions PA1, PA2, PA3 and PA4 surround the display region DA.

The signal transmitting part 230 is on a gate insulating layer 202 in the first peripheral region PA1. The signal transmitting part 230 may be formed from the source metal layer. The passivation layer 203 is formed on the signal transmitting part 230. The first pixel electrode pattern part 240 is on the passivation layer 203 corresponding to the signal transmitting part 230. A first alignment layer 204 is formed on the first pixel electrode pattern part 240. The first pixel electrode pattern part 240 is interposed between the passivation layer 203 and the first alignment layer 204 in the first peripheral region PA1 so that the adhesive strength between the passivation layer 203 in the first peripheral region PA1 and the first alignment layer 204 is increased.

The switching element 210, the pixel electrode 216 and the storage common line SCL are formed in each of the pixel parts P in the display region DA. The switching element 210 is electrically connected to one of the gate lines GL that include the gate metal layer and one of the source lines DL that include the source metal layer. The pixel electrode 216 is electrically connected to the switching element 210.

The switching element 210 includes the gate electrode 211, the source electrode 213, the drain electrode 214 and a channel portion 212.

The gate insulating layer 202 is on the gate electrode 211. The channel portion 212 is on the gate insulating layer 202 corresponding to the gate electrode 211. The source and drain electrodes 213 and 214 are on the channel portion 212. The passivation layer 203 is on the source and drain electrodes 213 and 214.

The pixel electrode 216 is on the passivation layer 203, and electrically connected to the drain electrode 214 through a contact hole 215 in the passivation layer 203. The first alignment layer 204 is on the pixel electrode 216.

The height difference compensating part 270, which may be formed from the gate metal layer, is formed in the third peripheral region PA3. The gate insulating layer 202 is on the height difference compensating part 270. The passivation layer 203 is on the gate insulating layer 202. The second pixel electrode pattern part 280 is on the passivation layer 203 corresponding to the height difference compensating part 270. The first alignment layer 204 is on the second pixel electrode pattern part 280. The second pixel electrode pattern part 280 is interposed between the passivation layer 203 and the first alignment layer 204 in the third peripheral region PA3 to increase the adhesive strength between the passivation layer 203 in the third peripheral region PA3 and the first alignment layer 204.

The first alignment layer 204 may be in the first base substrate 201 to cover the gate circuit part 220 to prevent a corrosion of the gate circuit part 220.

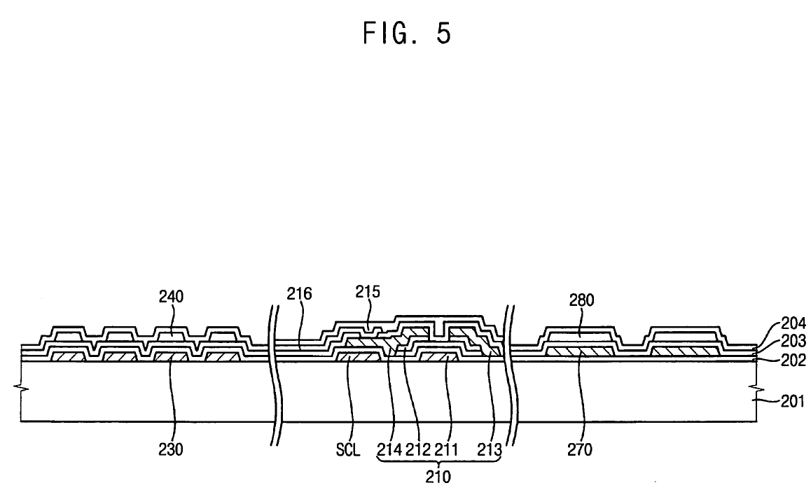

FIG. 5 is a cross-sectional view showing an array substrate in accordance with another embodiment of the present invention. The array substrate of FIG. 5 is the same as in FIGS. 1 to 4 except for a signal transmitting part and a height difference compensating part. Thus, the same reference numerals will be used to refer to the same or like parts as those described in FIGS. 1 to 4 and any further explanation concerning the above elements will be omitted. The signal transmitting part 230 in a first peripheral region PA1 includes a gate metal layer, and the height difference compensating part 270 in a third peripheral region PA3 includes a source metal layer.

A first pixel electrode pattern part 240 is on the signal transmitting part 230 that is formed from the gate metal layer. The second pixel electrode pattern part 280 is on the height difference compensating part 270 that is formed from the source metal layer.

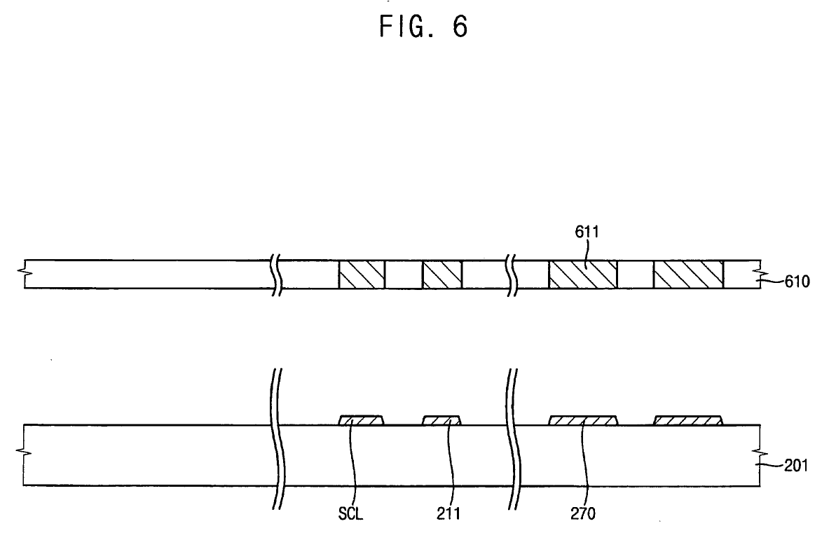

FIGS. 6 to 9 are cross-sectional views showing a method of manufacturing the array substrate shown in FIG. 3.

Referring to FIGS. 2 and 6, the gate metal layer is formed on the first base substrate 201. Gate metal patterns are formed through a photolithography process using a first mask 610 having first reticles 611.

The gate metal patterns include the gate lines GL in the display region DA, the storage common line SCL in the display region DA, the gate electrode 211 of the switching element 210 and the height difference compensating part 270 in the third peripheral region PA3. In another embodiment, the signal transmitting part 230 in the first peripheral region PA1 may be formed from the gate metal layer.

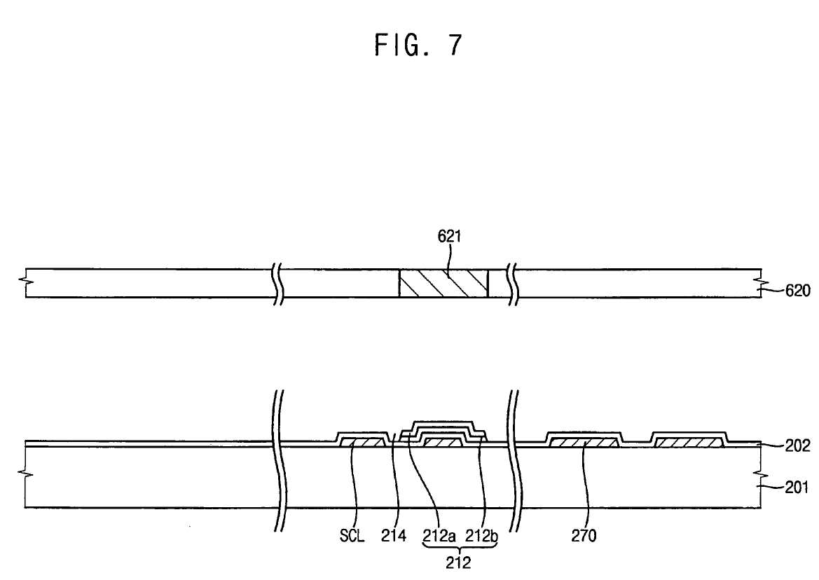

Referring to FIGS. 2 and 7, the gate insulating layer 202 is formed on the first base substrate 201 having the gate metal patterns. The gate insulating layer 202 may include an insulating material. Examples of the insulating material that can be used for the gate insulating layer 202 include silicon nitride, silicon oxide, etc.

An amorphous silicon layer 212a and an n+amorphous silicon layer 212b that is doped in situ are formed on the gate insulating layer 202 to form a channel layer. The channel layer is patterned through a photolithography process using a second mask 620 having second reticles 621 to form the channel portion 212 of the switching element 210.

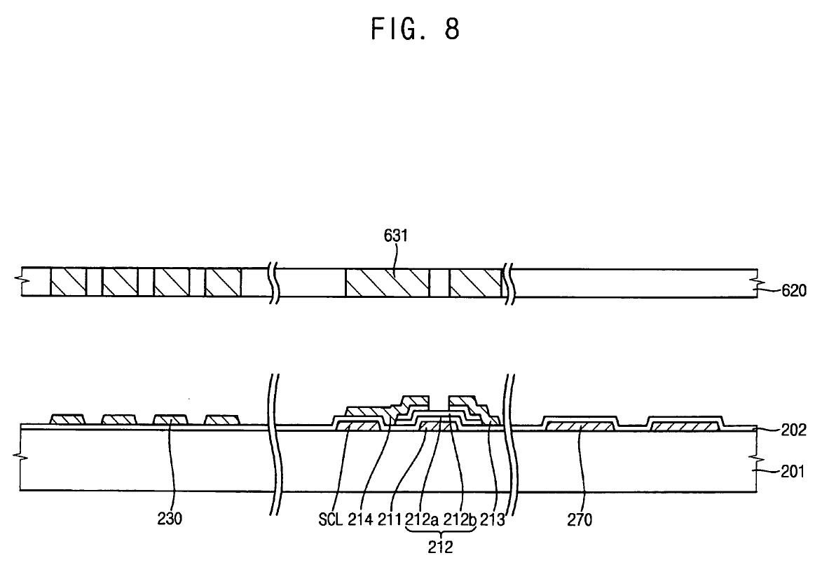

Referring to FIGS. 2 and 8, the source metal layer is formed on the first base substrate 201 having the channel portion 212 of the switching element 210. The source metal layer is patterned through a photolithography process using a third mask 630 having third reticles 631 to form source metal patterns.

The source metal patterns include the signal transmitting part 230 in the first peripheral region PA1, the source lines DL in the display region DA, the source electrode 213 and the drain electrode 214. In another embodiment, the height difference compensating part 270 in the third peripheral region PA3 may be formed from the source metal layer.

A portion of the n+amorphous silicon layer 212b of the channel portion 212 is removed using the source and drain electrodes 213 and 214 as a mask to define the channel region of the switching element 210.

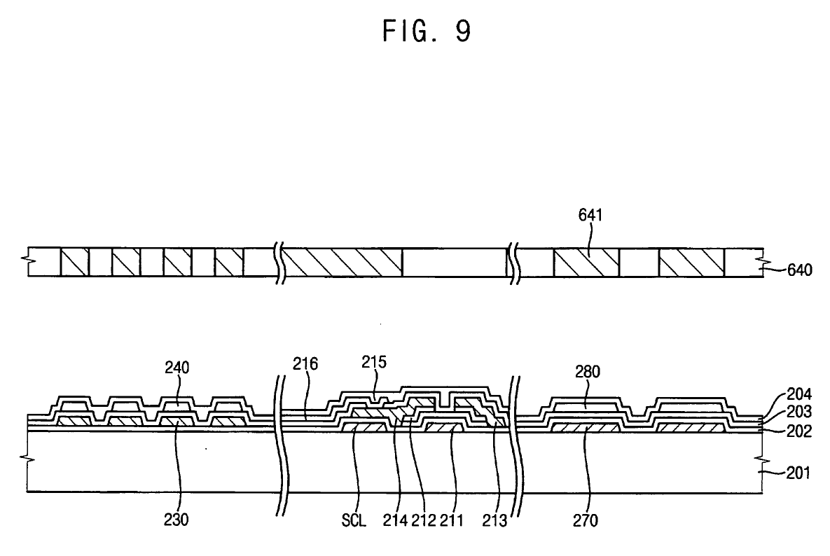

Referring to FIGS. 2 and 9, the passivation layer 203 is formed on the first base substrate 201 having the source metal patterns. The passivation layer 203 is partially removed to form the contact hole 215 in the display region DA and the contact holes corresponding to the first and second contact portions C11, C12, C21 and C22 in the first peripheral region PA1. The passivation layer 203 may be partially etched to form the contact holes using a mask having reticles corresponding to the contact holes.

The pixel electrode layer is formed on the first base substrate 201 having the contact holes. The pixel electrode layer includes a transparent conductive material. Examples of the transparent conductive material that can be used for the pixel electrode layer include indium tin oxide (ITO), indium zinc oxide (IZO), indium tin-zinc oxide (ITZO), etc.

The pixel electrode layer is patterned through a photolithography process using a fourth mask having fourth reticles 641 to form pixel electrode patterns.

The pixel electrode patterns include the pixel electrode 216 in the display region DA, the first pixel electrode pattern part 240 in the first peripheral region PA1 and the third pixel electrode pattern part 280 in the third peripheral region PA3. In addition, the pixel electrode patterns may further include the first and second contact portions C11, C12, C21 and C22 that are electrically connected between the signal transmitting part 230 and the first and second connecting lines 233a, 233b, 234a and 234b.

The first pixel electrode pattern part 240 corresponds to the signal transmitting part 230. The second pixel electrode pattern part 280 corresponds to the height difference compensating part 270. The first and second pixel electrode pattern parts 240 and 280 may be electrically insulated from the first and second contact portions C11, C12, C21 and C22.

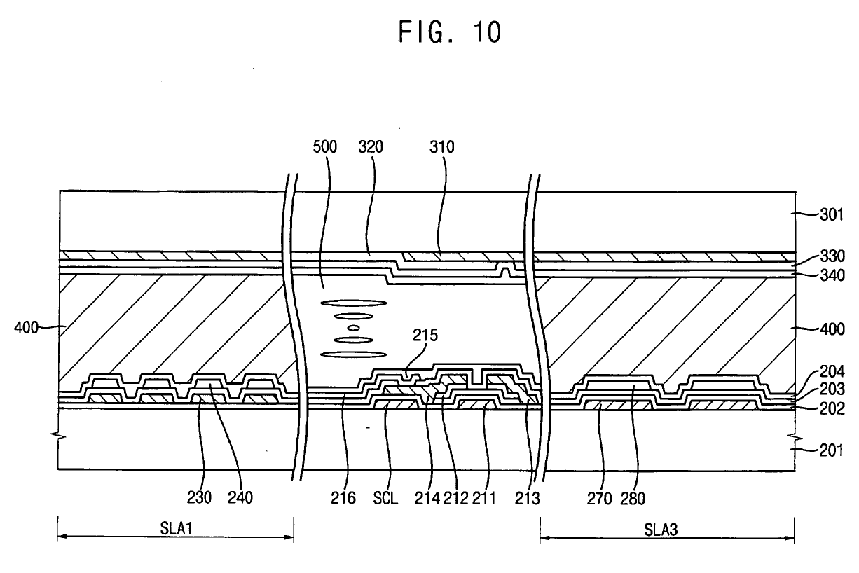

FIG. 10 is a cross-sectional view showing the LCD panel shown in FIG. 1.

Referring to FIGS. 2 and 10, the LCD panel 100 includes the array substrate 200, the second substrate 300, the sealing member 400 and the liquid crystal layer 500.

The array substrate 200 includes the display region DA and the first base substrate 201 having the first peripheral region PA1, the second peripheral region PA2, the third peripheral region PA3 and the fourth peripheral region PA4. The first, second, third and fourth peripheral regions PA1, PA2, PA3 and PA4 surround the display region DA.

The signal transmitting part 230 that includes the source metal layer is formed on the gate insulating layer 202 in the first peripheral region PA1. The passivation layer 203 is on the signal transmitting part 230. The first pixel electrode pattern part 240 corresponding to the signal transmitting part 230 is on the passivation layer 203.

Each of the pixel parts P in the display region DA includes the switching element 210, the pixel electrode 216 and the storage common line SCL. The switching element 210 is electrically connected to one of the gate lines GL that include the gate metal layer and one of the source lines DL that include the source metal layer. The pixel electrode 216 is electrically connected to the switching element 210. The switching element 210 includes the gate electrode 211, the source electrode 213, the drain electrode 214 and the channel portion 212.

The passivation layer 203 is formed on the source and drain electrodes 213 and 214. The pixel electrode 216 is electrically connected to the drain electrode 214 through the contact hole 215 of the passivation layer 203.

The height difference compensating part 270 that includes the gate metal layer is formed in the third peripheral region PA3. The gate insulating layer 202 is formed on the height difference compensating part 270. The passivation layer 203 is on the gate insulating layer 202. The second pixel electrode pattern part 280 corresponding to the height difference compensating part 270 is on the passivation layer 203.

A first alignment layer 204 that has a plurality of first alignment grooves is on the first and second pixel electrode pattern parts 240 and 280 in the peripheral regions and the pixel electrode 216 in the display region DA. The first alignment layer 204 may include a polyimide-based resin. The first alignment layer 204 may be formed on the first base substrate 201 to cover the gate circuit part 220, thereby decreasing the corrosion of the gate circuit part 220.

The second substrate 300 includes a second base substrate 301, a black matrix 310, a color filter 320, a common electrode layer 330 and a second alignment layer 340.

The black matrix 310 is on the second base substrate 301 to block a light leaked from the first, second, third and fourth peripheral regions PA1, PA2, PA3 and PA4 of the array substrate 200, and defines an inner space corresponding to the pixel parts P of the display region DA.

The color filter 320 is formed in the inner space defined by the black matrix 310 to display a color image.

The common electrode layer 330 is formed on the second base substrate 301 having the color filter 320. The common electrode layer 330 is the electrode that is positioned substantially parallel to the pixel electrode 216 of the array substrate 200. The common electrode layer 330 is a common electrode of the liquid crystal capacitor CLC defined by each of the pixel parts P.

A second alignment layer 340 that has a plurality of second alignment grooves is on the second base substrate 301. The second alignment layer 340 may include a polyimide-based resin.

The sealing member 400 is formed in the first, second and third attaching regions SLA1, SLA2 and SLA3 that are defined in the first, second, third and fourth peripheral regions PA1, PA2, PA3 and PA4 of the array substrate 200 so that the array substrate 200 is combined with the alignment substrate 300.

The sealing member 400 in the first peripheral region PA1 is on the first pixel electrode pattern part 240. The first pixel electrode pattern part 240 is interposed between the passivation layer 203 and the first alignment layer 204 in the first peripheral region PA1 to increase the adhesive strength between the passivation layer 203 and the first alignment layer 204 in the first peripheral region PA1, thereby increasing the adhesive strength between the array substrate 200 and the alignment substrate 300.

The sealing member 400 in the third peripheral region PA3 is on the second pixel electrode pattern part 280. The second pixel electrode pattern part 280 is interposed between the passivation layer 203 and the first alignment layer 204 in the third peripheral region PA3 to increase the adhesive strength between the passivation layer 203 and the first alignment layer 204 in the third peripheral region PA3, thereby increasing the adhesive strength between the array substrate 200 and the alignment substrate 300 The liquid crystal layer 500 is interposed between the array substrate 200 and the alignment substrate 300 that are combined with each other through the sealing member 400. The liquid crystal layer 500 is aligned by the first and second alignment layers 204 and 340 that are formed on the array substrate 200 and the alignment substrate 300, respectively. Liquid crystals in the liquid crystal layer 500 change their arrangement in response to an electric field, and thus the light transmittance of the liquid crystal layer 500 is changed, thereby displaying an image.

According to the present invention, a portion of the pixel electrode pattern is on the passivation layer to increase the adhesive strength between the passivation layer and the alignment layer.

In particular, a portion of the pixel electrode patterns is formed on the metal patterns in the attaching region to increase the adhesive strength between the alignment layer and the passivation layer, thereby increasing the adhesive strength between the array substrate and the alignment substrate.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. An array substrate including a display region having a plurality of pixel parts and a peripheral region surrounding the display region, the array substrate comprising:
a switching element in each of the pixel parts, the switching element being electrically connected to a gate line and a source line;
a pixel electrode electrically connected to the switching element;
a metal pattern part in the peripheral region;
a pixel electrode pattern part on the metal pattern part; and
an alignment layer on the pixel electrode and the pixel electrode pattern part.

2. The array substrate of claim 1, further comprising a sealing member that is deposited on the metal pattern part in the peripheral region.

3. The array substrate of claim 1, further comprising a gate circuit part in the peripheral region to apply a gate signal to the gate line.

4. The array substrate of claim 3, wherein the metal pattern part includes a signal transmitting part that transmits driving signals to the gate circuit part.

5. The array substrate of claim 4, wherein the metal pattern part is formed from a same layer as the source line.

6. The array substrate of claim 4, wherein the metal pattern part is formed from the same layer as the gate line.

7. The array substrate of claim 3, wherein the peripheral region comprises a first peripheral region in which the gate circuit part is formed and a second peripheral region positioned across the display region from the first peripheral region, and the metal pattern part further comprises a height difference compensating part in the second peripheral region.

8. The array substrate of claim 7, wherein the height difference compensating part is formed from the same layer as the gate line.

9. The array substrate of claim 7, wherein the height difference compensating part is formed from the same layer as the source line.

10. A method of manufacturing an array substrate including a display region and a peripheral region, the method comprising:
forming a plurality of switching elements, a plurality of signal transmitting parts and a gate circuit part that applies a driving signal to the switching elements through the signal transmitting parts on a substrate;
forming a passivation layer on the substrate, the passivation layer having a contact hole through which each of the switching elements is partially exposed;
forming a pixel electrode that is electrically connected to each of the switching elements through the contact hole and a plurality of first pixel electrode patterns on the passivation layer, the first pixel electrode patterns being on the signal transmitting lines; and
forming an alignment layer on the pixel electrode and the first pixel electrode patterns.

11. The method of claim 10, wherein each of the switching elements comprises a gate electrode that is formed from a gate metal layer and source and drain electrodes that are formed from a source metal layer, and the signal transmitting lines are formed from either the gate metal layer or the source metal layer.

12. The method of claim 10, wherein the peripheral region comprises a first peripheral region in which the gate circuit part is formed and a second peripheral region across the display region from the first peripheral region, and the forming of the switching elements further comprises forming a plurality of height difference compensating parts in the second peripheral region.

13. The method of claim 10, further comprising forming a sealing member corresponding to the first pixel electrode patterns.

14. The method of claim 12, wherein the forming of the first pixel electrode patterns further comprises forming a plurality of second pixel electrode patterns on the height difference compensating patterns.

15. The method of claim 14, further comprising forming a sealing member corresponding to the second pixel electrode patterns.

16. A liquid crystal display panel comprising:
a first substrate having a first alignment layer;
a second substrate having a display region and a peripheral region, the second substrate including:
a plurality of pixel electrodes in the display region;
a metal pattern part in the peripheral region;
a pixel electrode pattern part on the metal pattern in the peripheral region; and
a second alignment layer on the pixel electrodes and the pixel electrode pattern part;
a liquid crystal layer interposed between the first and second substrates; and
a sealing member interposed between the first and second substrates in the peripheral region to contain the liquid crystal layer between the first and second substrates.

17. The liquid crystal display panel of claim 16, wherein the pixel electrode pattern part has a substantially similar shape as the sealing member.

18. The liquid crystal display panel of claim 16, wherein the second substrate further comprises:
a switching element electrically connected to each of the pixel electrodes; and
a gate circuit part in the peripheral region to apply a gate signal to the switching element.

19. The liquid crystal display panel of claim 18, wherein the metal pattern part further comprises a signal transmitting part that transmits driving signals to the gate circuit part.

20. The liquid crystal display panel of claim 19, wherein the gate circuit part further comprises a shift register having a plurality of stages that are electrically connected to each other, and wherein the signal transmitting part comprises:
a start signal line that transmits a start signal to a first stage to start an operation of the stages;
a first clock signal line that transmits a first clock signal to control odd numbered stages of the stages;
a second clock signal line that transmits a second clock signal to control even numbered stages of the stages; and
a voltage line that transmits a driving voltage to the stages.

21. The liquid crystal display panel of claim 18, wherein the peripheral region comprises a first peripheral region in which the gate circuit part is formed and a second peripheral region across the display region from the first peripheral region, and the metal pattern part further comprises a height difference compensating part in the second peripheral region.
